(19) United States
(12) Patent Application Publication
(10) Pub. No.: US 2015/0291169 A1
(43) Pub. Date: Oct. 15, 2015

(54) METHOD FOR FREEING A VEHICLE BY ROCKING WHEN THE VEHICLE GOT STUCK

(71) Applicant: ZF Friedrichshafen AG, Friedrichshafen (DE)

(72) Inventors: Roland MAIR, Tettnang (DE); Marcus HAUG, Friedrichshafen (DE); Florian SCHNEIDER, Lindenberg im Allgau (DE); Andreas HEINZLER, Ravensburg (DE)

(21) Appl. No.: 14/684,557

(22) Filed: Apr. 13, 2015

(30) Foreign Application Priority Data
Apr. 14, 2014 (DE) 10 2014 207 088.0

(51) Int. Cl. B60W 30/18

(52) U.S. Cl. CPC B60W 30/18045; B60W 2510/125; B60W 2510/0275; B60W 2510/1005; B60W 2540/18

(57) ABSTRACT

A method of releasing a stuck vehicle with a rocking-free process which continues until the process is suppressed. The process is suppressed after a differential lock, closed at the beginning of the process, remains open for a predetermined time, or after reaching and maintaining a clutch load limit for a predetermined time, or after reaching a limit transmission gear, and maintaining the limit value for a predetermined time, or after registering the wheel rotational directions while a transmission gear engages, and after a predetermined time, in which the registered wheel rotational direction corresponds to a required direction for the gear engaged, or after a transmission gear is engaged, a transmission condition is maintained for a predetermined time, engaging a clutch for the predetermined time, a wheel speed difference limit value is reached, and the wheel speed difference remains at or falls below the speed difference limit value for the predetermined time.

This application claims priority from German patent application serial no. 10 2014 207 088.0 filed Apr. 14, 2014.

### FIELD OF THE INVENTION

The invention concerns a method for releasing a vehicle that is stuck, by means of a rocking-free process.

### BACKGROUND OF THE INVENTION

In certain weather conditions or poor road conditions it is possible for a vehicle to become stuck, for example in a depression or on slippery subsoil, so that the stuck position can no longer be left by driving off in a conventional manner. By starting off toward the obstacle, then disengaging the clutch, allowing the vehicle to roll back, and then repeating the procedure, a driver with a manual-shift vehicle can build up momentum and release the vehicle. This process is known as rocking free. For vehicles having an automatic transmission, an automated transmission or a multiple-clutch transmission, the method described above can only be used in some circumstances. Such vehicles are therefore often provided with an automatic method for rocking free, which enables the vehicle to be released from its stuck position.

The rocking-free process is either initiated by a driver, or automatically started in accordance with previously stored criteria such as a large difference between the speeds of the individual wheels. The driver can often activate the automatic initiation of the rocking-free process by means of a switch or by actuating a key, so that the rocking-free process is only started when the driver so wishes. Once the vehicle has been released the rocking-free process is terminated, for example by actuating the switch or key again.

DE 10 2004 017 422 A1 describes a method for implementing a rocking-free function, which in order to initiate the rocking-free process evaluates the wheel rotational speeds of the driven wheels of a vehicle. From that, the traction capacity of the corresponding wheels is estimated. Furthermore, among other things, information about rotational direction and inclination is used in order to optimize the rocking-free process. The rocking-free function can either be activated when a driver of the vehicle actuates a switch or key, or by a command from the on-board computer. Likewise an actuation is disclosed, which after registering that the vehicle is stuck, proceeds automatically or after questioning the driver. The rocking-free process is terminated when the driver actuates the switch or key, or automatically if vehicle-internal systems register that the vehicle is moving in one direction or over a fixed distance for a longer time. It is also disclosed that in vehicles having a distance-warning system, it is tested whether sufficient free areas exist around the vehicle concerned, to carry out the rocking free. If this is not the case, the rocking-free process is suppressed.

DE 101 28 853 A1 describes a method for rocking free and/or maneuvering a vehicle with a multiple-clutch transmission, in which the rocking-free process can only be started when the clutch arrangement is in a disengaged condition and/or the vehicle concerned is at rest. In addition it is disclosed that this special transmission condition can be produced by a driver of the vehicle by means of an operating arrangement which, for example, can consist of two switches or an operating lever. The vehicle's shift lever can also serve as the operating lever. The rocking-free process is initiated when the wheel-slip of the vehicle's driven wheels or the force acting in opposition to the drive torque of the vehicle exceed a predetermined limit value, or when the vehicle's speed falls below a set limit value. A rocking-free process ends when the vehicle comes to a standstill, or when the wheel-slip becomes too great.

Furthermore, vehicles with an automated transmission are also known, which have a rocking-free function. An implemented rocking-free process is activated by a driver by means of a key and the simultaneous engagement of the first or second reverse gear, or by engaging the first to the eighth forward gear while at the same time driving more slowly than a speed of 5 km/h. The rocking-free function is deactivated either if the driver actuates the key again, or by driving at a speed above or equal to 8 km/h.

For example, if a vehicle has become stuck on muddy ground and a rocking-free function is started in order to release the vehicle, it can happed after a successful release of the vehicle that the rocking-free function is not terminated. For example, the driver of the vehicle can forget to switch off the rocking-free function by actuating the switch or key. The result is that each time the vehicle starts off a rocking-free function is initiated. This makes starting uncomfortable for the driver and can lead to accidents. The same situation arises when speed or distance limits are chosen too high or are determined erroneously. It is therefore appropriate to establish further criteria that bring about a suppression of the rocking-free process, so that the rocking-free function is carried out safely by virtue of the automatic suppression.

### SUMMARY OF THE INVENTION

The purpose of the present invention is to provide an improved method for releasing a stuck vehicle, which by implementing an automatic suppression on the basis of pre-established criteria, prevents erroneous operation by a driver and prevents the continuation of the rocking-free process after the vehicle has already been released successfully. This allows the driver, once the vehicle has been released, to drive on comfortably even if he has forgotten to actively terminate the rocking-free function.

Starting from the prior art described at the beginning, the present invention proposes a method for releasing a stuck vehicle, in which method the stuck situation of the vehicle is recognized, a rocking-free process is initiated and the process is continued until it is automatically suppressed.

The automatic suppression of the rocking-free process takes place on the basis of previously determined criteria, which are defined by the conditions of the drive-train detected and evaluated by sensor means.

A vehicle is considered to be stuck when it is in a position in which a driver cannot move the vehicle in a desired direction starting from the position, because the wheel-slip of one or more vehicle wheels is too severe, i.e. the static friction of the wheels is too low because of the condition of the subsoil.

If the wheel-slip of the vehicle is detected by sensors and evaluated, for example by evaluating the speeds of the individual wheels compared with one another, appropriate software can deduce a stuck situation and automatically initiate a rocking-free process. Alternatively the driver may perceive that the vehicle is stuck and therefore initiate the rocking-free process himself.

In this context a rocking-free process is defined as a process for releasing a vehicle from a stuck position. During this the vehicle is first moved in a desired travel direction until a reversal point is reached. At that point there is a force equilibrium between a drive torque and a force opposing the drive torque, so that the vehicle cannot be moved beyond the point. When the reversal point is reached, the vehicle is moved in the direction opposite to the desired travel direction until another reversal point is reached, at which there is again a force equilibrium. The vehicle is then again moved in the desired travel direction until a further reversal point is reached. This reversal point is farther away from the starting position than the first reversal point. That process of rocking to and fro can be repeated as many times as necessary for the vehicle to be released from the stuck position when the drive torque of the vehicle is large enough to move the vehicle in the desired travel direction. In other words, the vehicle has then gone beyond the point of force equilibrium, i.e. an escape point from the stuck situation is opposite the previous reversal point. The movement of the vehicle in the direction opposite to the desired travel direction can take place either actively by an acceleration process, or passively for example by virtue of rolling back under gravity.

The rocking-free process is continued until it is suppressed. This means that the rocking-free process is stopped either when it has been taking place for a long enough time, for example after a successful release of the vehicle, or directly after its initiation, i.e. after a very short time, when the rocking-free process has only been operating for a fraction of a second.

The suppression of the rocking-free process takes place automatically. Here, ‘automatically’ means that when predetermined, vehicle-specific conditions arise, the rocking-free process can be suppressed automatically by vehicle-internal processes.

A first embodiment variant of the method according to the invention is characterized in that the rocking-free process is suppressed after the opening of at least one differential lock of the vehicle which is closed at the beginning of the rocking-free process, if the at least one differential lock is kept open for a predetermined time interval.

The predetermined time interval is in this case defined as a time interval limited by a time interval start value and a time interval end value. The time that passes between the time interval start and end values is the predetermined time interval. Depending on the vehicle the predetermined time interval can be set individually, and a minimum predetermined time interval of zero seconds can also be possible. If the predetermined time interval chosen is the minimum predetermined interval, the rocking-free process is automatically suppressed immediately by vehicle-internal processes if the previously defined, vehicle-specific conditions occur.

Before activation of the rocking-free process, the at least one differential lock is at first closed, i.e. engaged. If the rocking-free process has been activated and during the rocking-free process the at least one differential lock is opened, i.e. disengaged and remains in that open condition for the predetermined time interval, the rocking-free process is stopped. In addition or alternatively, if a change in the condition of the at least one differential lock as described above occurs, a start of the rocking-free process sequence is blocked. In other words the rocking-free process, having for example been called for by the driver, can be terminated immediately again. The block can last until the differential is closed again. The condition of the at least one differential lock is registered and evaluated by means of vehicle-internal sensors, and in doing this not only is the actual condition at the time registered, but also the previous condition is stored and evaluated along with it. In this way the condition change of the at least one differential lock can be determined.

In another embodiment variant of the method according to the invention, the rocking-free process is suppressed when a load limit of at least one clutch of the vehicle is reached and after the load limit has been maintaining or exceeded for a predetermined time interval.

The load limit of the at least one clutch is defined as a previously established level of the quantity of energy introduced into the at least one clutch. Alternatively, the load limit can be defined as a pre-established high power output level by the at least one clutch. In that case the large amount of energy is in a range close to the maximum quantity of energy that can be introduced into the at least one clutch and the high power output level is in a range close to the maximum power output level of the at least one clutch.

Before activation of the rocking-free process, the clutch loading is lower than the loading limit value. If the rocking-free process is activated and during this the loading of the at least one clutch reaches the loading limit and is maintained there or exceeds the limit for the predetermined time interval, the rocking-free process is stopped. Depending on the vehicle the predetermined time interval can be set individually, and a minimum predetermined time interval of zero seconds can also be possible. In addition or alternatively, if the loading limit value is maintained or exceeded as described above a start of the rocking-free process sequence can be blocked. In other words, for example after having been called for by the driver the rocking-free process can be terminated again immediately. The quantity of energy introduced into the clutch can for example be determined directly by sensor means and evaluated. By differentiating this quantity of energy as a function of time, the power output level of the at least one clutch can be determined.

According to a further embodiment variant of the method according to the invention, the rocking-free process is suppressed on reaching a gear of a transmission of the vehicle that serves as a limit value and if the limit is maintained or exceeded for a predetermined time interval.

The gear of the transmission that serves as the limit value has a small transmission ratio and is therefore preferably close to the highest gear that can be engaged, or alternatively the highest engageable gear.

Before the rocking-free process is activated a low gear with a high transmission ratio is engaged in the transmission, or the transmission is in neutral. If the rocking-free process is activated and during this the transmission is shifted to the gear that serves as the limit value, the rocking-free process is stopped if the gear serving as the limit is maintained for the predetermined time interval or shifted further to an even smaller transmission ratio. Depending on the vehicle the predetermined time interval can be set individually, and a minimum predetermined time interval of zero seconds can also be possible. In addition or alternatively, if the gear serving as the limit value is maintained or exceeded as described above a start of the rocking-free process sequence can be blocked. In other words, for example after having been called for by the driver, the rocking-free process can be terminated again immediately. The block can last until the gear serving as the limit is changed down again in the direction of higher transmission ratios or the transmission is shifted to neutral. The gear engaged in the transmission at the time can be detected and evaluated by vehicle-internal sensors.

According to a further embodiment variant of the method according to the invention the rocking-free process is suppressed after registering the rotational directions of the wheels of the vehicle when a gear of the vehicle's transmission is engaged and after the lapse of a predetermined time-interval, in which the registered rotational directions of the wheels correspond to a required wheel rotational direction appropriate for the gear engaged.

Preferably, for each wheel of the vehicle the corresponding rotational direction is detected by sensor means. Alternatively, the rotational direction of the wheels on the driven axle can be detected. Before the rocking-free process has been activated the rotational direction of the wheels is non-uniform, for example because the wheels on the driven axle are spinning so that the non-driven wheels are not rotating. Alternatively the vehicle may be at rest, i.e. the wheels have no rotational direction. Furthermore, before the rocking-free process has been activated the transmission is in neutral or a gear has been engaged in the transmission. If the rocking-free process is now activated and during this a gear is engaged in the transmission which corresponds to a travel direction, the rocking-free process is stopped if the required wheel rotational direction imposed by the gear engaged in the transmission during the predetermined time interval matches the wheel rotational direction detected. Depending on the vehicle the predetermined time interval can be set individually, and a minimum predetermined time interval of zero seconds can also be possible. The required vehicle wheel rotational direction is in this case defined as the wheel rotational direction imposed by the gear engaged, which corresponds to a travel direction, i.e. either a forward movement or a reverse movement. Alternatively, the gear can be engaged in the transmission only during the rocking-free process.

If a gear is engaged which corresponds to the “forward” travel direction but the vehicle has not yet been successfully released, the rotational direction of individual wheels can be opposite to the intended travel direction, i.e. to the required wheel rotational direction, since the vehicle repeatedly moves the opposite way, i.e. backward in order to carry out the rocking-free process. If a gear is engaged which corresponds to the “reverse” travel direction, what has been described above also applies. In addition, by detecting and evaluating the rotational direction phases of the wheels a movement of the wheels opposite to the specified travel direction can be determined.

By virtue of the repeated to and fro movement of the vehicle during the rocking-free process the predetermined time interval is preferably at least set as a maximum rocking-free process period. The maximum rocking-free process period is the maximum time required for the vehicle to move once in one direction and immediately after this, to move in a corresponding opposite direction during the rocking-free process. Alternatively, the predetermined time interval can be a longer interval than the maximum rocking-free process period.

In addition or alternatively, in the event that the registered wheel rotational direction corresponds to the required rotational direction for the predetermined time interval or for a period longer than the latter, a start of a rocking-free process sequence can be blocked. In other words, for example after having been called for by the driver, the rocking-free process can be terminated immediately. The block can last until the wheel rotational directions no longer correspond to the required wheel rotational direction.

In a further embodiment variant of the method according to the invention, the rocking-free process is suppressed after a transmission gear of the vehicle is engaged, a transmission condition with an engaged gear is maintained for a predetermined time interval, at least one clutch of the vehicle is closed, the at least one clutch is kept closed for the predetermined time interval, a speed difference of the wheels of the vehicle reaches a limit value, and the wheel speed difference is maintained at or below the limit value for the predetermined time interval.

In this case the speed difference limit value of the wheels is defined as a slight wheel-slip. The speeds of the individual wheels can be detected by sensor means and evaluated by forming the differences. Before the rocking-free process is activated the wheel speed difference is large. Furthermore, the at least one clutch is open and the transmission is in neutral. A transmission position and a clutch status can in each case be detected by respective vehicle-internal sensors and evaluated. If the rocking-free process is activated and during it, in succession or simultaneously both a gear is engaged in the transmission and also the clutch is closed and the speed difference reaches or falls below its limit value, the rocking-free process is stopped if these three conditions persist simultaneously for the predetermined time interval. Depending on the vehicle the predetermined time interval can be set individually, and a minimum predetermined time interval of zero seconds can also be possible. In addition or alternatively, if the conditions described above occur at the same time a start of the rocking-free process can be blocked. In other words, for example if the driver has called for a rocking-free process this can be terminated immediately. The block can last until at least one of the three conditions is eliminated.

Further characteristics and advantages of the invention emerge from the following description of example embodiments of the invention, with reference to the figures and drawings which show details essential to the invention, and from the claims. In any embodiment variant of the invention the individual characteristics can be implemented individually as such, or more than one at a time, in any combination.

### BRIEF DESCRIPTION OF THE DRAWINGS

Various example embodiments and details of the invention are described in more detail with reference to the figures explained below, which show:

FIG. 1: A sequence function of a method for releasing a stuck vehicle, according to an example embodiment relating to a differential lock of the vehicle,

FIG. 2: A sequence function of a method for releasing a stuck vehicle, according to an example embodiment relating to a clutch of the vehicle,

FIG. 3: A sequence function of a method for releasing a stuck vehicle, according to an example embodiment relating to a transmission of the vehicle,

FIG. 4: A sequence function of a method for releasing a stuck vehicle, according to an example embodiment relating to a transmission and to the wheels of the vehicle,

FIG. 5: A sequence function of a method for releasing a stuck vehicle, according to an example embodiment relating to a transmission, a clutch and the wheels of the vehicle.

### DETAILED DESCRIPTION OF THE PREFERRED EMBODIMENTS

In the following description of example embodiments of the present invention, the same or similar indexes are used for the same or similar elements shown in the various figures, so that there is no need for detailed repetitive descriptions of the elements.

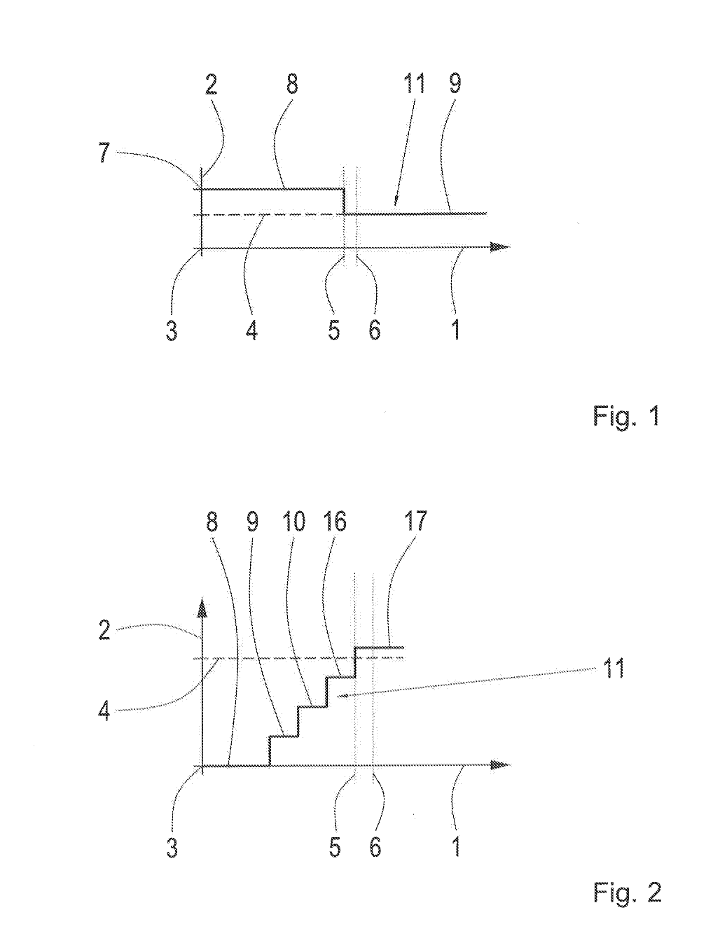

FIG. 1 shows a function sequence of a process for releasing a stuck vehicle according to an example embodiment that relates to a differential lock of the vehicle. The figure shows a coordinate system with an abscissa 1 and an ordinate 2 perpendicular thereto, with the abscissa and the ordinate intersecting at an origin 3. The abscissa is a time axis representing an increase of time in the positive direction. The origin 3 is a starting time-point at which a consideration of the function sequence begins, i.e. a zero-time point.

In the coordinate system defined by the abscissa 1 and the ordinate 2, a limit value 4 extends as a straight line, represented by a broken line parallel to and a distance away from the abscissa 1. The limit value represents an open condition of the differential lock of the vehicle to be released. In addition, in the coordinate system defined by the abscissa 1 and the ordinate 2, a time interval start value 5 extends as a straight line, indicated as a dotted line, parallel to and a distance away from the ordinate 2. A time interval end value 6, indicated as a dotted line, also extends in the coordinate system defined by the abscissa 1 and the ordinate 2 parallel to and a distance away from the ordinate 2, the time interval end value 6 also being a distance away from the time interval start value 5, with the latter closer to the ordinate 2 than is the time interval end value 6. An area between the time interval start 5 and end 6 values is a time zone that represents a predetermined time interval.

In the coordinate system defined by the abscissa 1 and the ordinate 2, a function 11 extends as a step function very largely parallel to and a distance away from the abscissa 1. The function 11 is divided into two sections 8, 9, which merge one into the other forming a rising step. A first function section 8 is a straight section extending in the coordinate system defined by the abscissa 1 and the ordinate 2, a distance away from the abscissa 1 and from the limit value 4, its distance from the abscissa 1 being larger than from the limit value 4, and represents a closed condition of the differential lock of the vehicle to be released. At a point of intersection 7 the first function section 8 intersects the ordinate 2. The intersection point 7 represents the starting time-point of this consideration. In the coordinate system defined by the abscissa 1 and the ordinate 2, a second function section 9 is a straight section extending a distance away from the abscissa 1 and coincident with the limit value 4. This second function section 9, as also the limit value 4, represent the open condition of the differential lock. Thus, the function 11 pictures the condition of the differential lock. The step-shaped transition between the first and second function sections 8, 9 marks the time interval start value 5.

The release of the vehicle by means of a rocking-free process begins at the starting time-point, which is characterized by the origin 3. At that time-point the differential lock of the vehicle is closed, as shown by the intersection point 7 and the first function section 8. The rocking-free process continues until the differential lock is opened, i.e. until the first function section 8 changes to the second function section 9. At that transition the time interval start value 5 is set and the predetermined time interval runs until the time interval end value 6. If the differential lock remains open during that predetermined interval, then the rocking-free process is suppressed from the time interval end value 6 onward.

FIG. 2 shows a function sequence of a method for releasing a stuck vehicle according to an example embodiment relating to a clutch of the vehicle. As in FIG. 1 a coordinate system is shown, with an abscissa 1 and an ordinate 2 which intersect at the origin 3. As in FIG. 1 the coordinate system is shown with the abscissa 1 and the ordinate 2 intersecting at the origin 3. As in FIG. 1 the abscissa 1 represents the time axis, picturing a positively increasing passage of time. The ordinate 2 represents a load of the clutch, which increases the farther a point is from the origin 3 on the ordinate 2 in a positive direction. The origin 3 is both the starting point, as in FIG. 1, and also represents the absence of any clutch load, i.e. a zero-point of the ordinate 2.

In the coordinate system defined by the abscissa 1 and the origin 2, a limit value 4 extends as a straight line, shown as a broken line, parallel to and a distance away from the abscissa 1. The limit value 4 represents a clutch load limit of the vehicle to be released. In addition, in the coordinate system defined by the abscissa 1 and the origin 2, a time interval start value 5 extends as a straight line, shown as a dotted line, parallel to and a distance away from the ordinate 2. In the coordinate system defined by the abscissa 1 and the origin 2, a time interval end value 6, again shown as a dotted line, also extends parallel to and a distance from the ordinate 2, with the time interval end value 6 a distance away from the time interval start value 5 and the latter closer to the ordinate 2 than is the time interval end value 6. An area between the time interval start 5 and end 6 values is a time zone representing a predetermined time interval.

In the coordinate system defined by the abscissa 1 and the origin 2, a function 11 extends in the form of a step function. The function 11 is divided into five sections 8, 9, 10, 16, 17, which merge one into another in the form of rising steps. A first function section 8 extends in the form of a straight section along the abscissa 1. A second function section 9 follows on from the first function section 8 and extends as a straight section parallel to and a distance from the abscissa 1. A third function section 10 also extends as a straight section parallel to and a distance from the abscissa 1, the third function section 10 being farther away from the abscissa 1 than is the second function section 9. The third function section 10 is connected to the second function section 9 by a step. A fourth function section 16 again extends as a straight section parallel to the abscissa 1, this fourth function section 16 being farther away from the abscissa than is the third function section 10, and being connected to the third function section 10 by a step. In addition a fifth function section 17 extends as a straight section parallel to the abscissa 1, the fifth function section being farther away from the abscissa 1 than are the fourth function section 16 and the limit value 4. The fourth function section 16 is connected by a step to the fifth function section 17. This transition marks the time interval start value 5. Each of the five function sections 8, 9, 10, 16, 17 represents a load situation of the clutch at a particular time, from no load in the first function section 8, through a low load in the second function section 9, up to a high load in the fifth function section 17. Thus, the function 11 pictures the clutch load variation with time.

The release of the vehicle by means of a rocking-free process begins at the starting point, characterized by the origin 3. At that point in time the clutch is not loaded, as shown by the first function section 8. During the rocking-free process the clutch load represented by the function 11 increases with increasing time in steps, as shown by the five function sections 8, 9, 10, 16, 17. By virtue of the transition between the fourth function section 16 and the fifth function section 17 the clutch load exceeds the limit value 4. At that transition point the time interval start value 5 is set and the predetermined time interval runs until the time interval end value 6. If the clutch load maintains a value during the predetermined time interval which is above the limit value 4, then from the time interval end value 6 onward the rocking-free process is suppressed.

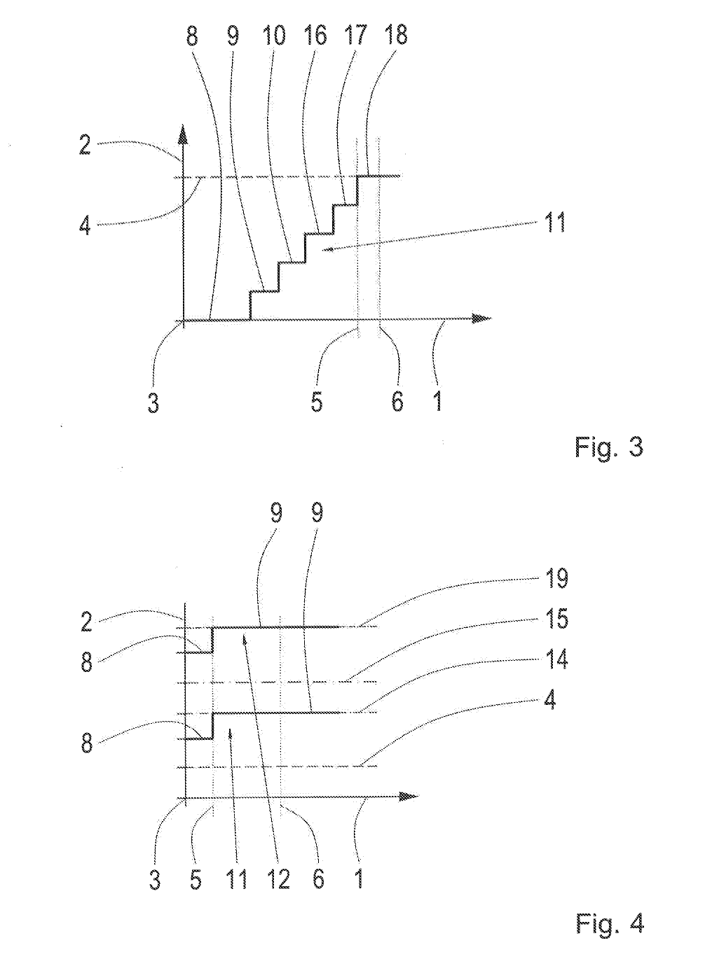

FIG. 3 shows a function sequence of a method according to the invention for releasing a stuck vehicle, according to an example embodiment relating to a transmission of the vehicle. As in FIG. 1 a coordinate system is shown, with an abscissa 1 and an ordinate 2 which intersect at the origin 3. As in FIG. 1 the abscissa 1 represents the time axis, picturing a positively increasing passage of time. The ordinate 2 represents the gears that can be engaged in a transmission of the vehicle, which are higher the farther a point in a positive direction on the ordinate is from the origin 3. The origin 3 is both the starting time-point as in FIG. 1, and also the lowest gear that can be engaged, i.e. the maximum possible transmission ratio.

In the coordinate system defined by the abscissa 1 and the origin 2, a limit value 4 extends as a straight line, shown as a broken line, parallel to and a distance away from the abscissa 1. The limit value 4 represents a maximum engageable gear of the transmission of the vehicle to be released. In addition, in the coordinate system defined by the abscissa 1 and the origin 2, a time interval start value 5 extends as a straight line, shown as a dotted line, parallel to and a distance away from the ordinate 2. In the coordinate system defined by the abscissa 1 and the origin 2, a time interval end value 6, again shown as a dotted line, also extends parallel to and a distance from the ordinate 2, with the time interval end value 6 a distance away from the time interval start value 5 and the latter closer to the ordinate 2 than is the time interval end value 6. An area between the time interval start 5 and end 6 values is a time zone representing a predetermined time interval.

In the coordinate system defined by the abscissa 1 and the origin 2, a function 11 extends in the form of a step function. The function 11 is divided into six sections 8, 9, 10, 16, 17, 18, which follow on into another in the form of rising steps. A first function section 8 extends in the form of a straight section along the abscissa 1. A second function section 9 follows on from the first function section 8 up a step and extends as a straight section parallel to and a distance from the abscissa 1. A third function section 10 also extends as a straight section parallel to and a distance from the abscissa 1, the third function section 10 being farther away from the abscissa 1 than is the second function section 9. The third function section 10 is connected to the second function section 9 by a step. A fourth function section 16 again extends as a straight section parallel to the abscissa 1, this fourth section 16 being farther away from the abscissa than is the third function section 10, and being connected to the third function section 10 by a step. In addition a fifth function section 17 extends as a straight section parallel to the abscissa 1, the fifth function section being farther away from the abscissa 1 than is the fourth function section 16. The fourth function section 16 is connected by a step to the fifth function section 17. A sixth function section 18 again extends as a straight section parallel to the abscissa 1, the sixth function section 18 being farther away from the abscissa 1 than is the fifth function section 17 and coinciding with the limit value 4. The fifth function section 17 is connected to the sixth function section 18 by a step, this transition marking the time interval start value 5.

In this case each of these six function sections 8, 9, 10, 16, 17, 18 represents a gear engaged in the transmission of the vehicle to be released at a particular point in time, from a lowest possible gear in the first function section 8, through a low gear in the second function section 9, up to a maximum possible gear in the sixth function section 18. Thus, the function 11 pictures the shifting of the gears in the transmission over time.

The release of the vehicle by means of a rocking-free process begins at the starting point, which is characterized by the origin 3. At that point in time the lowest, i.e. the minimum possible gear is engaged, as shown by the first function section 8. During the rocking-free process taking place, with increasing time the gears are engaged one after the other, as shown by the six function sections 8, 9, 10, 16, 17, 18 that follow one another in steps. By shifting into the highest possible gear of the transmission, represented by the sixth function section 18 of the function 11, the limit value 4 is reached. At the transition between the fifth function section 17 and the sixth function section 18, i.e. when the shift to the highest possible gear takes place, the time interval start value 5 is set and the predetermined time interval runs until the time interval end value 6. If the maximum possible gear, i.e. the limit value 4 is maintained during the predetermined time interval, the rocking-free process is suppressed from the time interval end value 6 onward.

FIG. 4 shows a function sequence of a method for releasing a stuck vehicle according to an example embodiment relating to a transmission and to the wheels of the vehicle. As in FIG. 1 a coordinate system is shown, with an abscissa 1 and an ordinate 2 which intersect at the origin 3. As in FIG. 1 the abscissa 1 represents the time axis, picturing a positively increasing passage of time, and as in FIG. 1 the origin 3 is the starting time.

In the coordinate system defined by the abscissa 1 and the ordinate 2, a limit value 4 extends as a straight line, shown as a broken line, parallel to and a distance away from the abscissa 1. The limit value 4 represents a transmission condition of the vehicle to be released, in which a reverse gear is engaged. In the coordinate system defined by the abscissa 1 and the ordinate 2 a further limit value 14, shown as a broken line, also extends as a straight line parallel to and a distance from the abscissa 1, this being farther away from the abscissa 1 than is the limit value 4. The limit value 14 represents a transmission condition of the vehicle to be released in which a forward gear is engaged. In other words the limit value 4 and the limit value 14 each represent a condition of the transmission.

In the coordinate system defined by the abscissa 1 and the ordinate 2 another limit value, shown as a dot-dash line, extends as a line parallel to and a distance away from the abscissa 1, this being farther away from the abscissa than is the further limit value 14. The other limit value 15 represents a backward-directed rotational direction of the wheels of the vehicle to be released. In addition, in the coordinate system defined by the abscissa 1 and the ordinate 2 another further limit value 19, shown as a dot-dash line, extends parallel to and a distance away from the abscissa 1, this limit value being farther away from the abscissa 1 than is the other limit value 15. The other further limit value 19 represents a forward-directed rotational direction of the wheels of the vehicle to be released. In other words, the other limit value 15 and the other further limit value 19 each represent a travel direction of the vehicle to be released.

Furthermore, in the coordinate system defined by the abscissa 1 and the ordinate 2 a time interval start value 5 extends as a line, shown as a dotted line, parallel to and a distance away from the ordinate 2. A time interval end value 6, again shown as a dotted line, also extends parallel to and a distance away from the ordinate 2, the time interval end value 6 being a distance away from the time interval start value 5 with the latter closer to the ordinate 2 than is the time interval end value 6. An area between the time interval start 5 and end 6 values is a time zone that represents a predetermined time interval.

In the coordinate system defined by the abscissa 1 and the ordinate 2 a function 11 extends as a step function. The function 11 is divided into two sections 8, 9 which are connected to one another by a rising step. A first function section 8 of the function 11 extends in the form of a straight line section parallel to the abscissa 1 half-way between the limit value 4 and the further limit value 14, and represents a neutral transmission position of the vehicle to be released. A second function section 9 of the function 11 also extends in the form of a straight section parallel to the abscissa 1, but coincident with the further limit value 14. Thus, the function 11 represents a transmission position. The step between the first function section 8 and the second function section 9 of the function 11 marks the time interval start value 5.

In addition, in the coordinate system defined by the abscissa 1 and the ordinate 2 a further function 12 extends in the form of a step function. This further function 12 is also divided into two section 8, 9 connected to one another by a rising step. A first function section 8 of the further function 12 extends as a straight section parallel to the abscissa 1 and half-way between the other limit value 15 and the further other limit value 19, and represents the absence of any rotational direction of the wheels of the vehicle to be released. In other words, the vehicle is at rest. A second function section 9 of the further function 12 also extends in the form of a straight section parallel to the abscissa 1, but coincident with the other further limit value 19. Thus, the further function 12 represents a rotational direction of the wheels of the vehicle to be released. The step between the first function section 8 and the second function section 9 of the function 12 marks the time interval start value 5. This, the step in the function 11 coincides with the step in the further function 12.

The release of the vehicle by a rocking-free process begins at the starting time characterized by the origin 3. At that starting time the transmission is in neutral as shown by the first function section 8 of the function 11, and the vehicle to be released is at rest, i.e. the wheels of the vehicle to be released have no rotational direction, as shown by the first function section 8 of the further function 12. During the rocking-free process the transmission setting is changed in such manner that a forward gear is engaged, as indicated by the second function section 9 of the further function 12. The further limit value 14 and the other further limit value 19 are reached. Owing to the change from the first function section 8, both of the function 11 and of the further function 12, to the second function section 9 in each case, the time interval start value 5 is set. The predetermined time interval then runs until the time interval end value 6. If during the predetermined time interval the engaged forward gear is maintained and the wheels move only forward, then the rocking-free process is suppressed from the time interval end value 6 onward.

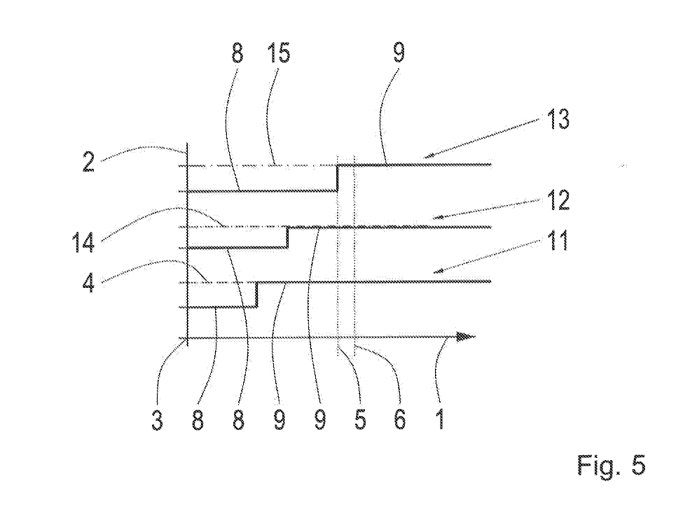

FIG. 5 shows a function sequence of a method for releasing a stuck vehicle, according to an example embodiment relating to a transmission, a clutch and the wheels of the vehicle. As in FIG. 1 a coordinate system is shown, with an abscissa 1 and an ordinate 2 which intersect at the origin 3. As in FIG. 1 the abscissa 1 represents the time axis, picturing a positively increasing passage of time, and as in FIG. 1 the origin 3 is the starting time.

In the coordinate system defined by the abscissa 1 and the ordinate 2, a limit value 4 extends as a straight line, shown as a broken line, parallel to and a distance away from the abscissa 1. The limit value 4 represents a transmission condition of the vehicle to be released, in which a gear is engaged. In the coordinate system defined by the abscissa 1 and the ordinate 2 a further limit value 14, represented as a dot-dash line, is also in the form of a straight line parallel to and a distance away from the abscissa 1, this being farther away from the abscissa 1 than is the limit value 4. The limit value 14 represents a closed clutch condition of the vehicle to be released. Another limit value 15, shown as a line of dots and longer dashes, extends in the coordinate system defined by the abscissa 1 and the ordinate 2 as a line parallel to and a distance away from the abscissa 1, this being farther away from the abscissa 1 than is the further limit value 14. The other limit value 15 represents a small speed difference of the wheels of the vehicle, i.e. a small degree of wheel-slip.

In addition, in the coordinate system defined by the abscissa 1 and the ordinate 2 a time interval start value 5 extends as a straight line, shown as a dotted line, parallel to and a distance away from the ordinate 2. In the coordinate system defined by the abscissa 1 and the ordinate 2, a time interval end value 6 shown as a dotted line also extends parallel to and a distance away from the ordinate 2, the time interval end 6 is also a distance away from the time interval start value 5, with the latter closer to the ordinate 2 than is the time interval end value 6. As area between the time interval start 5 and end 6 values is a time zone representing a predetermined time interval.

In the coordinate system defined by the abscissa 1 and the ordinate 2, a function 11 extends as a step function. The function 11 is divided into two sections 8, 9 which are connected to one another by a rising step. A first function section 8 of the function 11 extends in the form of a straight line section parallel to the abscissa 1 and represents a neutral transmission position of the vehicle to be released. A second function section 9 of the function 11 also extends in the form of a straight section parallel to and a distance away from the abscissa 1, this being farther away from the abscissa 1 than is the first function section 8 of the function 11. The second function section 9 of the function 11 coincides with the limit value 4. Thus, the function 11 represents the transmission condition of the vehicle to be released.

Furthermore, in the coordinate system defined by the abscissa 1 and the ordinate 2, a further function 12 extends in the form of a step function. The further function 12 is divided into two function sections 8, 9 connected to one another by a rising step. A first function section 8 of the further function 12 extends in the form of a straight section parallel to and a distance from the abscissa 1, being farther away from the abscissa 1 than is the limit value 4. Thus, the first function section 8 of the function 12 represents an open condition of the clutch of the vehicle to be released. A second function section 9 of the further function 11 also extends in the form of a straight section parallel to and a distance from the abscissa 1, this second section 9 being farther away from the abscissa 1 than is the first function section 8 of the further function 12. The second function section 9 of the further function 12 is connected to the first function section 8 of the further function 12, the step between them occurring at a later time-point than the change between the two function sections 8. 9 of the function 11. Thus, the second function section 9 of the further function 12 coincides with the further limit value 14. The further function 12 represents the clutch condition of the vehicle to be released.

In addition, in the coordinate system defined by the abscissa 1 and the ordinate 2, another function 13 extends in the form of a step function. The other function 13 is divided into two function sections 8, 9 connected to one another by a rising step. A first function section 8 of the other function 13 extends in the form of a straight section parallel to and a distance from the abscissa 1, being farther away from the abscissa 1 than is the further limit value 14. In this case the first function section 8 of the other function 13 indicates a large speed difference of the wheels of the vehicle to be released, i.e. a large degree of wheel-slip. A second function section 9 of the other function 13 also extends in the form of a straight section parallel to and a distance from the abscissa 1, being farther away from the abscissa 1 than is the first function section 8 of the other function 13. This second function section 9 of the other function 13 is connected to the first function section 8 thereof, the step between them occurring at a later time than the change between the first and second function sections 8, 9 of the function 11 and than the change between the first and second function sections 8, 9 of the further function 12. In this case the second function section 9 of the other function 13 coincides with the other limit value 15. Thus, the other function 13 represents the speed difference situation of the wheels of the vehicle to be released.

The change from the first function section 8 of the other function 13 to the second function section 9 thereof marks the time interval start value 5. Thus, the time interval end value 6 is set only after both the function 11 and the further function 12 and also the other function 13 have changed from their respective first function sections to their second function sections 9, i.e. they have reached their associated limit values 4, 14, 15.

The release of the vehicle by a rocking-free process begins at the starting time, which is characterized by the origin 3. At that starting time the transmission of the vehicle to be released is in neutral, its clutch is open and the speed difference of the wheels of the vehicle to be released is large, as shown respectively by the first function section 8 of the function 11, the further function 12 and the other function 13. During the rocking-free process the transmission setting is changed in such manner that a gear is engaged. The limit value 4 is reached, as shown by the second function section 9 of the function 11. Then the clutch condition is changed, i.e. the clutch is closed. Thereby, the further limit value 14 is reached, as shown by the second function section 9 of the further function 12. After that a small difference in the speed of the wheels occurs. The other limit value 15 is reached, as shown by the second function section 9 of the other function 13. When two of the three limit values 4, 14, 15 have been reached the time interval start value 5 is set by the change of one of the functions 11, 12, 13 to the corresponding last, not yet reached limit value. The predetermined time interval runs until the time interval end value 6. If during the predetermined time interval the engaged gear, the open clutch condition and the small wheel speed difference all persist, the rocking-free process is suppressed.

The example embodiments described and illustrated in the figures have only been chosen as examples. For instance, the time interval start value can be the same as the time interval end value so that the predetermined time interval lasts zero seconds. For example the clutch of a vehicle to be released can have more than the loading steps shown in FIG. 2. It is also possible for the variation of the clutch load to differ from that shown in FIG. 2, being for example a linear, quadratic, cubic, hyperbolic, or any other function. Furthermore, for example already when the limit value is reached the rocking-free process can be suppressed.

For instance, the transmission of the vehicle to be released can have more gears than those represented in FIG. 3. Furthermore the limit value, associated with the highest engageable gear in FIG. 3, can also be set lower, for example one or two gear steps below the highest engageable gear.

Furthermore the simultaneous occurrence, shown in FIG. 4, of the exclusive forward movement of the wheels of the vehicle to be released and the engagement of a forward gear can for example take place a certain time apart. In that case the time interval start value is not set until both criteria exist together. In other words, when a forward gear has already been engaged the time interval start value is set when an exclusively forward movement is detected, or when an exclusively forward movement has been detected the time interval start value is set when a forward gear is engaged. At the beginning of the rocking-free process in FIG. 4, the vehicle to be released can for example already have a transmission position with a gear engaged. This and the criteria described in connection with FIG. 4 can also be used for an exclusively reverse movement and a reverse gear.

Moreover, the three criteria described in FIG. 5, namely the transmission condition, the clutch condition and the speed difference condition of the wheels of the vehicle to be released, can follow one another in a sequence other than that shown. For example, first a small speed difference of the wheels of the vehicle to be released can be detected, and then a gear is engaged and the clutch is closed. In each case the time interval start value is only set when the last of the three criteria reaches the corresponding limit value. Likewise, in FIG. 5 at the beginning of the rocking-free process the vehicle can be at rest, i.e. the speed difference of the wheels of the vehicle to be released is almost non-existent since the wheels are not moving.

Different example embodiments can be combined with one another as regards individual features. Moreover, one example embodiment can be supplemented by one or more features of another example embodiment.

### INDEXES

1 Abscissa
2 Ordinate
3 Origin
4 Limit value
5 Time interval start value
6 Time interval end value
7 Intersection point
8 First function section
9 Second function section
10 Third function section
11 Function
12 Further function
13 Other function
14 Further limit value
15 Other limit value
16 Fourth function section
17 Fifth function section
18 Sixth function section
19 Other further limit value

1-11. (canceled)

12. A method of releasing a stuck vehicle, the method comprising the steps of:
recognizing a stuck situation of the vehicle,
initiating and continuing a rocking-free process until the rocking-free process is automatically suppressed,
suppressing the rocking-free process after:
opening at least one differential lock of the vehicle that was closed at the initiation of the rocking-free process, and
keeping the at least one differential lock open for a predetermined time interval.

13. A method for releasing a stuck vehicle, the method comprising the steps of:
recognizing a stuck situation of the vehicle,
initiating and continuing a rocking-free process until the rocking-free process is automatically suppressed,
suppressing the rocking-free process after:
reaching a load limit value of at least one clutch of the vehicle, and
either maintaining or exceeding the load limit value of the at least one clutch for a predetermined time interval.

14. The method according to claim 13, further comprising the step of detecting a quantity of energy introduced into the at least one clutch as the load limit value for the at least one clutch of the vehicle.

15. The method according to claim 13, further comprising the step of determining a power output of the at least one clutch as the load limit value for the at least one clutch of the vehicle.

16. A method of releasing a stuck vehicle, the method comprising the steps of:
recognizing a stuck situation of the vehicle,
initiating and continuing a rocking-free process until the rocking-free process is automatically suppressed,
suppressing the rocking-free process after:
reaching a gear of a transmission of the vehicle that serves as a limit value, and
either maintaining or exceeding the limit value for a predetermined time interval.

17. The method according to claim 16, further comprising the step of defining the gear of the transmission of the vehicle that serves as a limit value is a highest gear in the transmission of the vehicle that is engageable.

18. The method according to claim 16, further comprising the step of defining the gear of the transmission of the vehicle that serves as a limit value as having a transmission ratio that corresponds approximately to the transmission ratio of the highest gear that is engageable.

19. A method for releasing a stuck vehicle, the method comprising the steps of:
recognizing a stuck situation of the vehicle,
initiating and continuing a rocking-free process until the rocking-free process is automatically suppressed,
suppressing the rocking-free process after:
registering rotational directions of the wheels of the vehicle while a gear of a transmission of the vehicle is engaged, and
after a lapse of a predetermined time interval, in which the registered rotational directions of the wheels corresponds to a required rotational direction of the wheels appropriate for the gear engaged.

20. The method according to claim 19, further comprising the step of determining the rotational direction for each wheel of the vehicle.

21. The method according to claim 19, further comprising the step of determining the rotational direction for each wheel of a driven axle of the vehicle wheel.

22. A method of releasing a stuck vehicle, the method comprising the steps of:
recognizing a stuck situation of the vehicle,
initiating and continuing a rocking-free process until the rocking-free process is automatically suppressed,
suppressing the rocking-free process after:
engaging a gear of a transmission of the vehicle,
maintaining a transmission condition with a gear engaged for a predetermined time interval,
engaging at least one clutch of the vehicle,
keeping the at least one clutch engaged for the predetermined time interval,
reaching a speed difference limit value of the wheels of the vehicle, and
the wheel speed difference either remains at or fails below the speed difference limit value for the predetermined time interval.
